(19) United States
(12) Patent Application Publication
(10) Pub. No.: US 2025/0006089 A1
(43) Pub. Date: Jan. 2, 2025

(54) ACTIVE MATRIX SUBSTRATE AND DISPLAY DEVICE INCLUDING THE SAME

(71) Applicant: Sharp Display Technology Corporation, Kameyama City (JP)

(72) Inventors: Takahiro YAMAGUCHI, Kameyama City (JP); Kohei HOSOYACHI, Kameyama City, Mie (JP); Yuhichiroh MURAKAMI, Kameyama City (JP); Shige FURUTA, Kameyama City (JP); Hidekazu YAMANAKA, Kameyama City (JP)

(21) Appl. No.: 18/639,329

(22) Filed: Apr. 18, 2024

(30) Foreign Application Priority Data
Jun. 27, 2023 (JP) 2023-105183

(51) Int. Cl. G09G 3/00; G02F 1/1345; G02F 1/1362; G06F 3/041; G06F 3/044; G09G 3/3233; G09G 3/36

(52) U.S. Cl. CPC G09G 3/006; G02F 1/13452; G02F 1/136286; G06F 3/0412; G06F 3/04164; G09G 3/3648; G02F 2201/503; G06F 3/044; G09G 3/3233; G09G 2310/0297; G09G 2330/12; G09G 2354/00

(57) ABSTRACT

In an IC mounting region in which a driver IC is to be mounted in an active matrix substrate that is used in a display device, an inspection circuit is formed together with a plurality of driving-side pads for outputting, from the driver IC, a plurality of video data signals representing an image to be displayed. The inspection circuit includes a plurality of inspection transistors connected separately to each of these driving-side pads, inspection signal lines, and an inspecting control line. The inspection signal lines and the inspecting control line are placed opposite the driving-side pads across the inspection transistors, and there are no wire intersections between the inspection transistors and the driving-side pads.

### CROSS-REFERENCE TO RELATED APPLICATION

The present application claims priority from Japanese Application No. JP2023-105183, filed on Jun. 27, 2023, the content of which is hereby incorporated by reference into this application.

### BACKGROUND

### 1. Field

The present disclosure relates to a display device including an active matrix substrate and, more particularly, to an inspection circuit formed in an active matrix substrate.

### 2. Description of the Related Art

A display device such as an active matrix liquid crystal display device includes an active matrix substrate including a plurality of data lines (also called “source lines”), a plurality of scanning lines (also called “gate lines”) intersecting the plurality of data lines, and a plurality of pixel circuits arranged in a matrix along the plurality of data lines and the plurality of scanning lines. This active matrix substrate also includes a source line driving circuit connected to a plurality of source lines serving as the plurality of data lines and a gate line driving circuit connected to a plurality of gate lines serving as the plurality of scanning lines. A display panel including this active matrix substrate includes a driver IC that outputs a video signal representing an image to be displayed and a timing control signal for display. The source line driving circuit drives the plurality of source lines in accordance with a video signal from the driver IC and the gate line driving circuit drives the plurality of gate lines in accordance with a timing control signal from the driver IC, whereby an image represented by the video signal is displayed by the plurality of pixel circuits.

Such an active matrix display device includes an inspection circuit for inspecting the active matrix substrate. Conventionally, this inspection circuit has been placed near the source line driving circuit. However, in recent years, there has been no choice but to place the inspection circuit within a region in which the driver IC is mounted, as a narrower frame has been in demand to widen a display region while suppressing an increase in dimensional size of the display device (see, for example, paragraph 0018 of Japanese Unexamined Patent Application Publication No. 2019-39970).

In such an active matrix display device, a wide region is not secured for a region in which the driver IC is mounted (hereinafter referred to as “IC mounting region”). For this reason, the placement in the IC mounting region of switching elements of the inspection circuit and signal lines for inspection signals (testing video signals or other signals) causes a switching element of the inspection circuit to be connected to a pad for making an electrical connection between a video data line for transmitting a video signal from the driver IC to the source line driving circuit and a terminal of the driver IC, resulting in a conventional configuration in which a wire connecting the pad with the switching element intersects a wire for an inspection signal (see FIG. 4, which will be described below). In an IC mounting region for which a wide area is unable to be secured, the inclusion of such an intersection results in a short distance between the intersection and the pad, so that a protection element is unable to be provided between the intersection and the pad. For this reason, a current entering through the pad due to ESD (electrostatic discharge) is not restricted, and an excessive voltage is applied to the intersection, so that there may occur a breakdown (hereinafter referred to as “ESD breakdown”) of an interlayer insulating film at the intersection.

Meanwhile, Japanese Patent No. 4807365 discloses a configuration for, in a liquid crystal display device including an active matrix substrate, protecting, from a breakdown of an insulating film due to static electricity, a semiconductor circuit such as a scanning line driving circuit formed in the active matrix substrate. In this active matrix substrate, the semiconductor circuit is connected to a wire crossing a first end (terminal) to which an electrical signal is supplied from an outside source and a second end to which no electrical signal is supplied from an outside source, a protection circuit is provided in a section of the wire between the semiconductor circuit and the first end, and a protection circuit is provided in a section of the wire between the semiconductor circuit and the second end or other sections (see, for example, claim 1, paragraphs 0024 to 0029, and FIG. 1). This configuration makes it possible to suppress a breakdown due to static electricity in a semiconductor circuit such as a scanning line driving circuit. However, this configuration is unable to suppress a breakdown of an interlayer insulating film at an intersection near a pad (terminal) in an inspection circuit placed in an IC mounting region as noted above.

It is desirable to, in a configuration in which an inspection circuit is formed in a region in an active matrix substrate in which a driver IC is mounted, boost resistance to an ESD breakdown in the mounting region.

### SUMMARY

According to an aspect of the disclosure, there is provided an active matrix substrate having a display unit in which a plurality of pixel circuits are formed. The active matrix substrate includes a plurality of driving data lines for transmitting, to the plurality of pixel circuits, a driving data signal representing an image to be displayed on the display unit and an inspection circuit formed in an IC mounting region in which an integrated circuit configured to generate a plurality of driving data signals for directly driving the plurality of driving data lines or a plurality of video data signals for indirectly driving the plurality of driving data lines via a predetermined driving circuit is to be mounted. In the IC mounting region, a plurality of driving-side pads are formed for the integrated circuit to output the plurality of driving data signals or the plurality of video data signals. The inspection circuit includes a plurality of switching elements corresponding separately to each of the plurality of driving-side pads, at least one inspection signal line for transmitting an inspection signal for inspecting the active matrix substrate, and an inspecting control line for transmitting a control signal to be supplied to the plurality of switching elements. Each of the plurality of switching elements has a first conducting terminal connected to a corresponding one of the driving-side pads, a second conducting terminal connected to any of the at least one inspection signal line, and a control terminal connected to the inspecting control line. The at least one inspection signal line is formed opposite the plurality of driving-side pads across the plurality of switching elements.

According to an aspect of the disclosure, there is provided an active matrix substrate having a display unit having formed therein a plurality of sensor electrodes arranged in a matrix for a touch panel function. The active matrix substrate includes an inspection circuit formed in an IC mounting region in which an integrated circuit configured to generate a plurality of sensor signals to be supplied to the plurality of sensor electrodes is to be mounted and a plurality of sensor signal lines for transmitting the plurality of sensor signals to the plurality of sensor electrodes. In the IC mounting region, a plurality of driving-side pads are formed for the integrated circuit to output the plurality of sensor signals. The inspection circuit includes a plurality of switching elements corresponding separately to each of the plurality of driving-side pads, at least one inspection signal line for transmitting an inspection signal to be supplied to the plurality of sensor electrodes, and an inspecting control line for transmitting a control signal to be supplied to the plurality of switching elements. Each of the plurality of switching elements has a first conducting terminal connected to a corresponding one of the driving-side pads, a second conducting terminal connected to any of the at least one inspection signal line, and a control terminal connected to the inspecting control line. The at least one inspection signal line is formed opposite the plurality of driving-side pads across the plurality of switching elements.

According to an aspect of the disclosure, there is provided a display device including either of the aforementioned active matrix substrates.

### BRIEF DESCRIPTION OF THE DRAWINGS

FIG. 1 is a block diagram showing an overall configuration of a display device including an active matrix substrate according to a first embodiment;

FIG. 2 is a circuit diagram showing a configuration of a pixel circuit in the first embodiment;

FIG. 3 is a diagram showing a layout pattern of an inspection circuit in the first embodiment;

FIG. 4 is a diagram showing a layout pattern of an inspection circuit in a comparative example;

FIG. 5 is a layout diagram for explaining a problem with a layout of the inspection circuit in the comparative example;

FIG. 6 is a circuit diagram for explaining a feature of the layout pattern of the inspection circuit in the first embodiment;

FIG. 7 is a diagram showing a layout pattern of an inspection circuit in an active matrix substrate according to a second embodiment;

FIG. 8 is a diagram showing a layout pattern of an inspection circuit in an active matrix substrate according to a third embodiment;

FIG. 9 is a diagram showing a layout pattern of an inspection circuit in an active matrix substrate according to a fourth embodiment;

FIG. 10 is a diagram showing a layout pattern of an inspection circuit in an active matrix substrate according to a fifth embodiment;

FIG. 11 is a timing chart for schematically explaining the operation of an in-cell touch panel that is achieved in the active matrix substrate according to the fifth embodiment; and

FIG. 12 is a block diagram showing an overall configuration of a display device including an active matrix substrate according to a modification of the first to fourth embodiments.

### DESCRIPTION OF THE EMBODIMENTS

The following describes embodiments with reference to the accompanying drawings. In each transistor that is referred to below, a gate terminal is equivalent to a control terminal, one of a drain terminal and a source terminal to a first conducting terminal, and the other to a second conducting terminal. Further, the term “connection” herein means an “electrical connection” unless otherwise noted, and without departing from the scope of the present disclosure, encompasses not only a case where it means a direct connection but also a case where it means an indirect connection via another element.

### 1. First Embodiment

### 1.1 Overall Configuration and Brief Overview of Operation

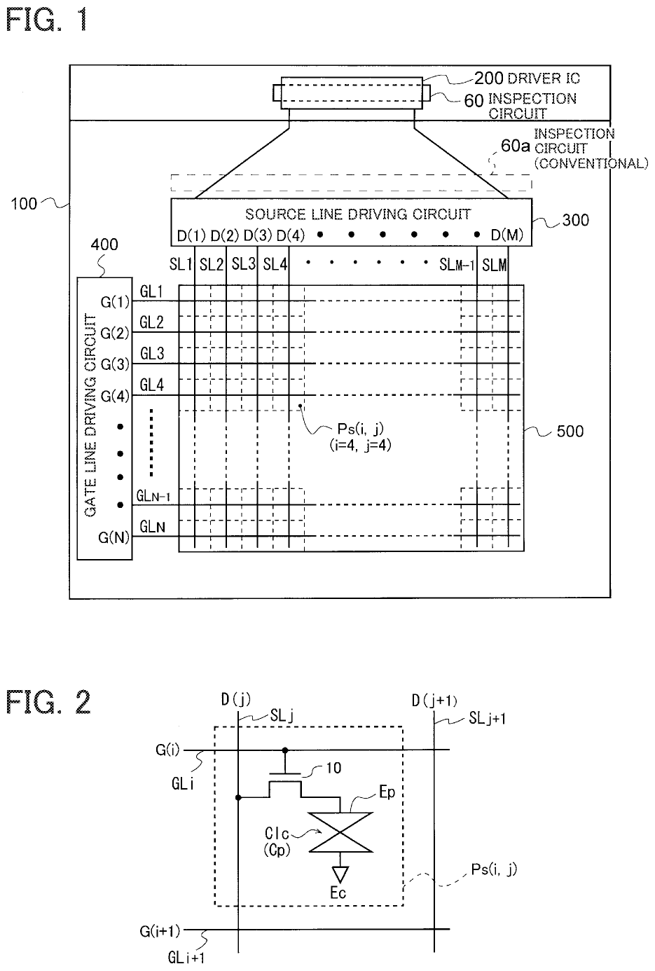

FIG. 1 is a block diagram showing an overall

configuration of a display device including an active matrix substrate 100 according to a first embodiment (hereinafter referred to as “display device of the first embodiment”). In the active matrix substrate 100, the after-mentioned plurality of pixel circuits of a display unit 500 are formed, and a source line driving circuit 300 serving as a data line driving circuit and a gate line driving circuit 400 serving as a scanning line driving circuit are formed integrally with the plurality of pixel circuits; furthermore, a driver IC 200 serving as a driving integrated circuit is mounted (e.g. COG-mounted). Further, an inspection circuit 60 is formed in a region in the active matrix substrate 100 situated below the driver IC 200, i.e. a region in which the driver IC 200 is mounted (called “IC mounting region” as mentioned earlier). The inspection circuit 60 is a circuit for electrically inspecting the active matrix substrate 100.

To the display device of the first embodiment, an input signal Sin is supplied from an outside source. The input signal Sin contains an image signal representing an image to be displayed and a timing control signal for display of the image. In accordance with the input signal Sin, the driver IC 200 generates a plurality of video data signals Dv1 to DVp representing the image to be displayed, a data-side control signal Scd, and a scanning-side control signal Scs.

The plurality of video data signals Dv1 to DVp are supplied to the source line driving circuit 300 via the after-mentioned video data lines DvL1 to DvLp, and the data-side control signal Scd and the scanning-side control signal Scs are supplied to the source line driving circuit 300 and the gate line driving circuit 400, respectively, via signal lines (not illustrated). Further, to the inspection circuit 60, testing video signals Tsig1 and Tsig2 and a testing control signal (also referred to as “inspecting control signal”) Tcon are supplied as inspection signals from an outside source via wires (not illustrated in FIG. 1) after the active matrix substrate 100 has been manufactured and before the driver IC 200 is mounted.

As shown in FIG. 1, in the active matrix substrate 100, the display unit 500 is provided with source lines SL1 to SLM serving as a plurality of (M) driving data lines, gate lines GL1 to GLN serving as a plurality of (N) scanning lines intersecting the plurality of source lines SL1 to SLM, a plurality of (M×N) pixel circuits Ps(i,j) (i=1 to N, j=1 to M) arranged in a matrix along the plurality of source lines SL1 to SLM and the plurality of gate lines GL1 to GLN. Each of the pixel circuits Ps(i,j) corresponds to any one of the plurality of source lines SL1 to SLM and corresponds to any one of the plurality of gate lines GL1 to GLN. Further, the video data lines DvL1 to DvLp, via which the video data signals Dv1 to Dvp outputted from the driver IC 200 are transmitted to the source line driving circuit 300, are formed in the active matrix substrate 100.

The source line driving circuit 300 in the present embodiment generates M driving data signals D(1) to D(M) in accordance with the video data signals Dv1 to Dvp and the data-side control signal Scd from the driver IC 200 and applies the M driving data signals D(1) to D(M) to the source lines SL1 to SLM, respectively. The source line driving circuit 300 is, but is not limited to, a demultiplexing circuit in the present embodiment. For example, the source line driving circuit 300 may be constituted by p secondary source drivers connected separately to each of the p video data lines DvL1 to DvLp. In this case, each of the secondary source drivers drives M/p driving data lines in accordance with a video data signal Dvk supplied from the driver IC 200 via a corresponding video data line DvLk (where M is a multiple of p). For example, each of the p secondary source drivers is allocated M/p driving data lines out of the M source lines SL1 to SLM, and each secondary source driver may be dot-sequential or line-sequential driving circuit configured to drive the allocated M/p driving data lines in accordance with a video data signal Svk supplied as a serial image signal via a corresponding video data line DvLk (k=1 to p).

The demultiplexing circuit as the source line driving circuit 300 in the present embodiment includes p demultiplexers 301, 302, . . . , and 30p corresponding separately to each of p driving data line groups obtained by grouping the M source lines SL1 to SLM into groups of m=M/p driving data lines (where M is a multiple of p and m≥2). The demultiplexers 301 to 30p receive the time-division multiplexed video data signals Dv1 to Dvp via the video data lines DvL1 to DvLp, respectively, from the driver IC 200 and each receive a demultiplexed control signal via a signal line (not illustrated) from the driver IC 200. Each demultiplexer 30k (k=1 to p) generates m driving data signals D(mk−m+1), D(mk−m+2), . . . , and D(mk) by demultiplexing, in accordance with the demultiplexed control signal, the video data signal Dvk received from the driver IC 200 and applies the m driving data signals D(mk−m+1), D(mk−m+2), . . . , and D(mk) to source lines SLmk−m+1, SLmk−m+2, . . . , and SLmk, respectively.

The gate line driving circuit 400 generates, in accordance with the scanning-side control signal Scs from the driver IC 200, scanning signals G(1), G(2), . . . , and G(N) for sequentially selecting the N gate lines GL1, GL2, . . . , and GLN and applies the scanning signals G(1), G(2), . . . , and G(N) to the N gate lines GL1, GL2, . . . , and GLN, respectively. Such driving of the gate lines GL1 to GLN by the gate line driving circuit 400 causes the N gate lines GL1 to GLN to be sequentially selected for each horizontal period, and such sequential selection of the gate lines GL1 to GLN is repeated with one frame period as a cycle. The term “horizontal period” here refers to a period of a portion equivalent to one line of an image that is displayed on the basis of horizontal scanning and vertical scanning.

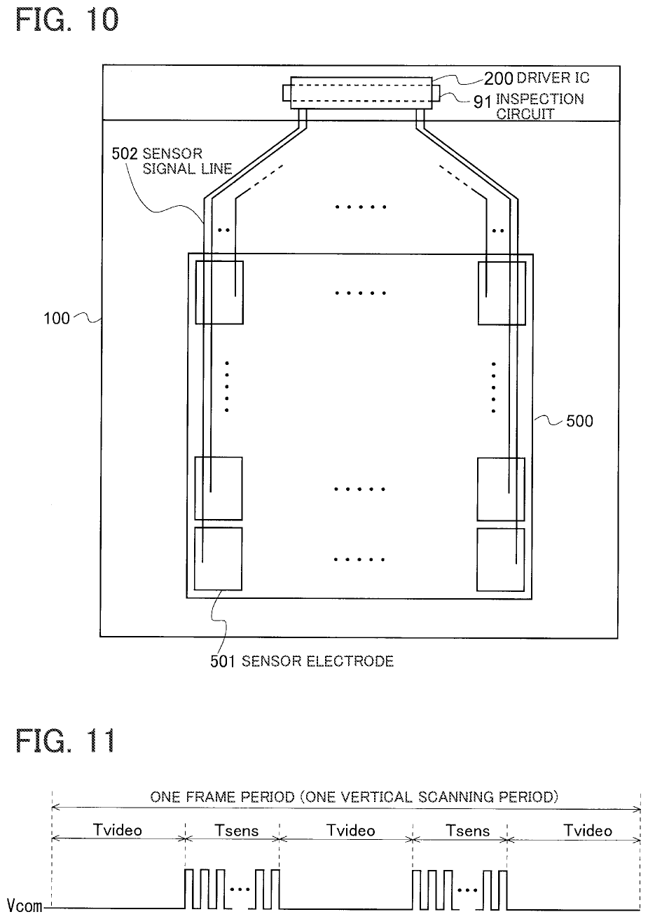

FIG. 2 is a circuit diagram showing a configuration of a pixel circuit Ps(i,j) corresponding to the ith gate line GLi and the jth source line SLj (i=1 to N, j=1 to M). The pixel circuit Ps(i,j) includes a thin-film transistor (hereinafter referred to as “pixel TFT”) 10 serving as a switching element whose gate terminal is connected to the corresponding gate line GLi and whose source terminal is connected to the corresponding source line SLj and a pixel electrode Ep connected to a drain terminal of the pixel TFT 10. Combined with a common electrode Ec commonly provided to the N×M pixel circuits Ps(i,j) and a liquid crystal layer sandwiched between the pixel electrode Ep and the common electrode Ec and commonly provided to the N×M pixel circuits Ps(i,j), each pixel circuit Ps(i,j) constitutes a pixel forming unit for forming one pixel of the image to be displayed. Moreover, the pixel electrode Ep and the common electrode Ec form a liquid crystal capacitor Clc that constitutes a pixel capacitor Cp. Typically, an auxiliary capacitor is provided in parallel with the liquid capacitor Clc to certainly retain a voltage in the pixel capacitor Cp; however, a description and an illustration of the auxiliary capacitor is omitted, as the auxiliary capacitor is not directly related to the present disclosure. The common electrode Ec may also be utilized as an electrode for use in touch position detection, and in this case, the common electrode Ec is segmented into a plurality of electrodes (see FIG. 10, which will be described below).

Adoptable examples of the pixel TFT 10 of the pixel circuit Ps(i,j) include a thin-film transistor whose channel layer is made of amorphous silicon, a thin-film transistor (LTPS-TFT) whose channel layer is made of low-temperature polysilicon, and a thin-film transistor (hereinafter referred to as “oxide TFT”) whose channel layer is made of an oxide semiconductor. An adoptable example of the oxide TFT is a thin-film transistor having an In-Ga-Zn-O-based semiconductor layer (i.e. an oxide semiconductor layer containing indium gallium zinc oxide). The source line driving circuit 300, the gate line driving circuit 400, and the inspection circuit 60 are formed integrally with pixel circuits Ps(1,1) to Ps(N,M) in the active matrix substrate 100. Accordingly, the channel layers of TFTs that are used in these circuits 300, 400, and 60 are made of the same semiconductor material as the channel layers of the pixel TFTs 10 of the pixel circuits Ps(1,1) to Ps(N,M).

In the display device of the first embodiment thus configured, the source line driving circuit 300 drives the source lines SL1 to SLM in accordance with the video data signals Dv1 to Dvp and the data-side control signal Scd that the driver IC 200 generates in accordance with the input signal Sin, and the gate line driving circuit 400 drives the gate line GL1 to GLN in accordance with the scanning-side control signal Scs that the driver IC 200 generates in accordance with the input signal Sin. As a result, the image represented by the input signal Sin is formed by the N×M pixel circuits Ps(1,1) to Ps(N,M) of the display unit 500.

In order to, after the active matrix substrate 100 has been fabricated and before the driver IC 200 is mounted mainly at the production stage, electrically inspect the source line driving circuit (in the present embodiment, the demultiplexing circuit) 300 and the pixel circuits Ps(1,1) to Ps(N,M) formed on top of the active matrix substrate 100, the inspection circuit 60 generates testing video data signals TDv1 to TDvp in accordance with the testing video signals Tsig1 and Tsig2 and the inspecting control signal Tcon, which are inspection signals supplied from an outside source, and applies the testing video data signals TDv1 to TDvp to the video data lines DvL1 to DvLp, respectively.

### 1.2 Layout of Inspection Circuit

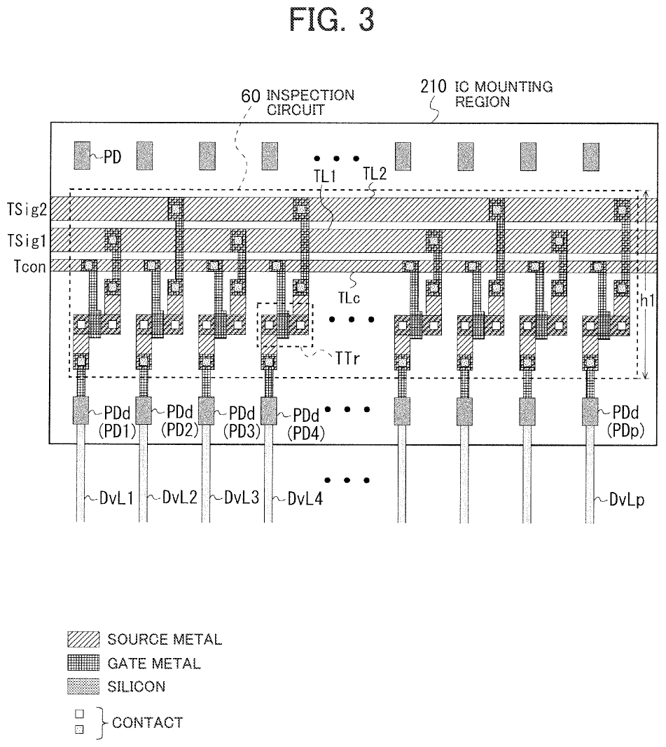

FIG. 3 is a diagram showing a layout pattern of the inspection circuit 60, which is formed in an IC mounting region 210 in the present embodiment. In FIG. 3, the diagonally shaded patterns each represent a pattern of a wire (called “source metal”) formed by a metal material at a certain layer of the active matrix substrate 100, the grating hatched patterns each represent a pattern of a wire (called “gate metal”) formed by a metal material at another layer (this gate metal is also used for wiring of a gate line serving as a scanning line), and the dot hatched patterns each represent a pattern of a region (called “silicon” here) formed by a semiconductor material at still another layer. Further, the non-hatched small squares each represent a contact hole for making an electrically conductive connection between a pattern of source metal and a pattern of silicon, and the dot hatched patterns each represent a contact hole for making an electrically conductive connection between a pattern of source metal and a pattern of gate metal. Such a method of representation of the layout pattern of the inspection circuit 60 is also used in cases of illustration of layout patterns of inspection circuits 70, 80, and 90 in other embodiments to be described later.

As shown in FIG. 3, in the IC mounting region 210, pads PD are formed in positions corresponding separately to each of terminals of the driver IC 200 when the driver IC 200 is mounted in the active matrix substrate 100. Of those pads PD, p pads PD1 to PDp (hereinafter referred to as “driving-side pads”, which are denoted by reference sign “PDd” in a case where there is no need to make distinctions among the driving-side pads PD1 to PDp) are arranged in a horizontal direction beside the display unit 500 (i.e. beside the source line driving circuit 300). To the driving-side pads PD1 to PDp, the video data lines DvL1 to DvLp are connected, respectively. The driving-side pads PD1 to PDp are pads for the driver IC 200 mounted in the IC mounting region 210 to output the video data signals Dv1 to Dvp. The term “horizontal direction” refers to a direction of extension of the gate line GLi (in the drawing, a right-left direction). Further, a direction of extension of a source line SL (in the drawing, an up-down direction) is hereinafter referred to as “vertical direction”.

The inspection circuit 60 includes p inspection transistors TTr1 to TTrp, arranged in the horizontal direction, that correspond to the video data lines DvL1 to DvLp, respectively, a first inspection signal line TL1 formed as a wire extending in the horizontal direction, a second inspection signal line TL2 formed as a wire extending in the horizontal direction, and an inspecting control line TLc formed as a wire extending in the horizontal direction. Note here that an inspection transistor TTr connected to a video data line DvLk is denoted by reference sign “TTrk” (k=1 to p) to be distinguished from the other inspection transistors TTr (the same applies below). Each inspection transistor TTr includes a source formed by source metal, a drain formed by source metal, a channel region formed by silicon, and gate metal provided above or below the channel region via an insulating film, and functions as a switching element. As shown in FIG. 3, in the inspection circuit 60, the first inspection signal line TL1, the second inspection signal line TL2, and the inspecting control line TLC are placed opposite the driving-side pads PD1 to PDp across the inspection transistors TTr1 to TTrp.

Further, as shown in FIG. 3, the source and the drain, which are formed by source metal, in each inspection transistor TTrk are arranged in the horizontal direction (in the drawing, a right-left direction). One of the source and the drain (which is a left-side electrode of the source and the drain in the drawing; hereinafter referred to as “first conducting terminal”) is connected to a corresponding video data line DvLk (k=1 to p) via a gate metal wire and one driving-side pad PDk of the p driving-side pads PDd, and the other of the source and drain (which is a right-side electrode of the source and the drain in the drawing; hereinafter referred to as “second conducting terminal”) is connected to the first inspection signal line TL1 or the second inspection signal line TL2. In the example shown in FIG. 3, the second conducting terminal of an odd-numbered inspection transistor TTro (o is an odd number) of the p inspection transistors TTr1 to TTrp arranged in the horizontal direction is connected to the first inspection signal line TL1 via a gate metal wire intersecting the inspecting control line TLC, and the second conducting terminal of an even-numbered inspection transistor TTre (e is an even number) of the p inspection transistors TTr1 to TTrp arranged in the horizontal direction is connected to the second inspection signal line TL2 via a gate metal wire intersecting the inspecting control line TLC and the first inspection signal line TL1. The gate of each inspection transistor TTrk (k=1 to p) is connected to the inspecting control line TLc by a gate metal wire.

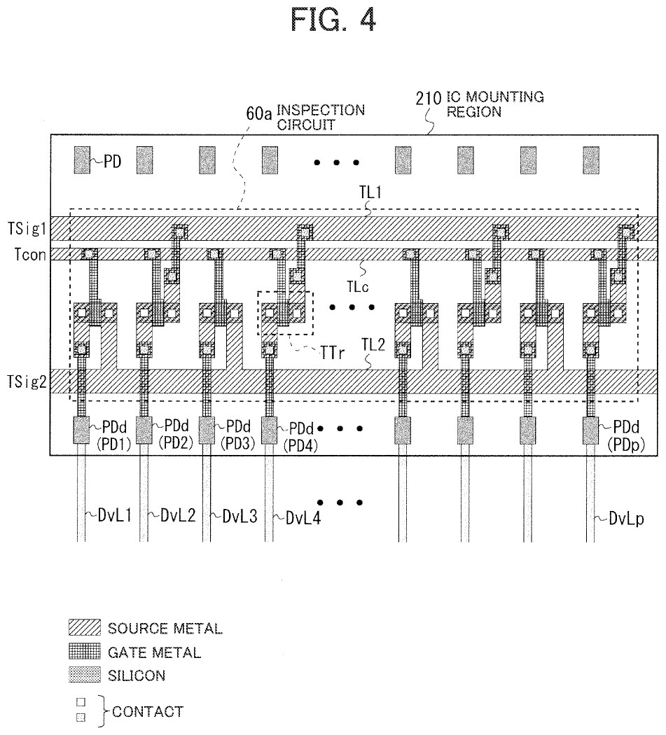

FIG. 4 is a diagram showing a layout pattern of a publicly-known inspection circuit 60a serving as a comparative example of such an inspection circuit 60. In the layout pattern of the inspection circuit 60a as the comparative example, as in the first embodiment, p inspection transistors TTr1 to TTrp serving as switching elements are arranged in a horizontal direction, and a first inspection signal line TL1 and an inspecting control line TLC are placed opposite driving-side pads PD1 to PDp across the inspection transistors TTr1 to TTrp. However, a second inspection signal line TL2 is placed between the inspection transistors TTr1 to TTrp and the driving-side pads PD1 to PDp.

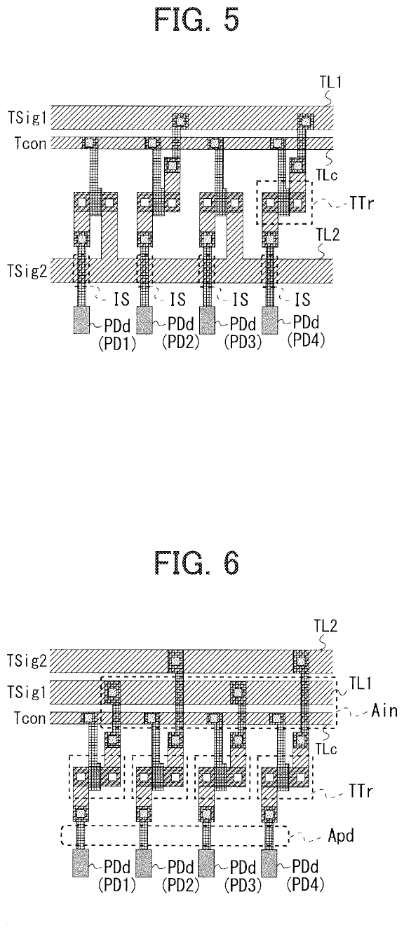

FIG. 5 is a layout diagram for explaining a problem with a layout pattern of such a comparative example, and shows part of the layout pattern of the inspection circuit 60a as the comparative example. In the layout pattern of the comparative example, as stated previously, the second inspection signal line TL2 is placed between the inspection transistors TTr1 to TTrp and the driving-side pads PD1 to PDp; therefore, as shown in FIG. 5, there is a portion (hereinafter referred to as “wire intersection”) IS in which a gate metal wire connecting the first conducting terminal (left-side electrode of the source and the drain in the drawing) of each inspection transistor TTr with a driving-side pad PDd and the second inspection signal line TL2 intersect. Since it is difficult to secure a wide area as the IC mounting region 210, the distance between the wire intersection IS and the pad PDk is so short that a protection element such as a protection diode or a protection resistor is unable to be placed between them. For this reason, a current entering the inspection circuit 60a through the pad PDk due to ESD (electrostatic discharge) is not restricted, and an excessive voltage is applied to the wire intersection IS, so that depending on conditions (such as film quality and film thickness) of an interlayer insulating film at the wire intersection IS, there may occur a breakdown of the interlayer insulating film, i.e. an ESD breakdown.

On the other hand, the layout pattern of the inspection circuit 60 in the present embodiment, in which as shown in FIG. 3, the second inspection signal line TL2 is formed as a wire placed opposite the driving-side pads PDd across the inspection transistors TTr, is high in resistance (hereinafter referred to as “ESD resistance”) to an ESD breakdown caused by an external current entering due to ESD. This point is explained with reference to FIG. 6.

FIG. 6 is a layout diagram for explaining a feature of the layout pattern of the inspection circuit 60 in the present example, and shows part of the layout pattern of the inspection circuit 60. As shown in FIG. 6, in this layout pattern, a gate metal wire connecting each inspection transistor TTr with a driving-side pad PDd does not intersect another wire, as the wires, namely the first inspection signal line TL1, the second inspection signal line TL2, and the inspecting control line TLC, are placed opposite the driving-side pads PD1 to PDp across the inspection transistors TTr.

### 1.3 Effects

As noted above, according to the present embodiment, in the layout pattern of the inspection circuit 60 formed in the IC mounting region 210, as shown in FIGS. 3 and 6, all of the wires, namely signal lines (i.e. the first and second inspection signal lines TL1 and TL2 and the inspecting control line TLc) for transmitting signals, such as the first and second inspection signals Tsig1 and Tsig2 and the inspecting control signal Tcon, that are to be supplied to the inspection transistors TTr are formed opposite the driving-side pads PD (PD1 to PDp), to which the video data lines DvL1 to DvLp are connected, across the inspection transistors TTr (TTr1 to TTrp). For this reason, in the layout pattern of the inspection circuit 60, unlike in the layout pattern in the comparative example (see FIGS. 4 and 5), there are no wire intersections in a region Apd between the inspection transistors TTr (TTr1 to TTrp) and the driving-side pads PD (PD1 to PDp). Accordingly, an external current entering the inspection circuit 60 due to ESD does not cause an ESD breakdown in the region Apd, and the amount of the current is restricted by passage through the inspection transistors TTr, so that there is a drop in voltage that is applied to the interlayer insulating film at the wire intersections after passage through the inspection transistors TTr. The present embodiment thus described brings about further improvement than ever before in ESD resistance of the inspection circuit 60 formed in the IC mounting region 210 of the active matrix substrate 100 for narrowing the frame of the display device.

### 2. Second Embodiment

Next, a liquid crystal display device including an active matrix substrate according to a second embodiment (hereinafter referred to as “display device of the second embodiment”) is described. Since the display device of the second embodiment is the same in configuration as the display device of the first embodiment (see FIGS. 1 and 2) except for the layout pattern of an inspection circuit formed in an IC mounting region in the active matrix substrate, identical or corresponding components are given identical reference signs and not described in detail. Components and actions of the present embodiment that are not newly described are the same as those of the first embodiment.

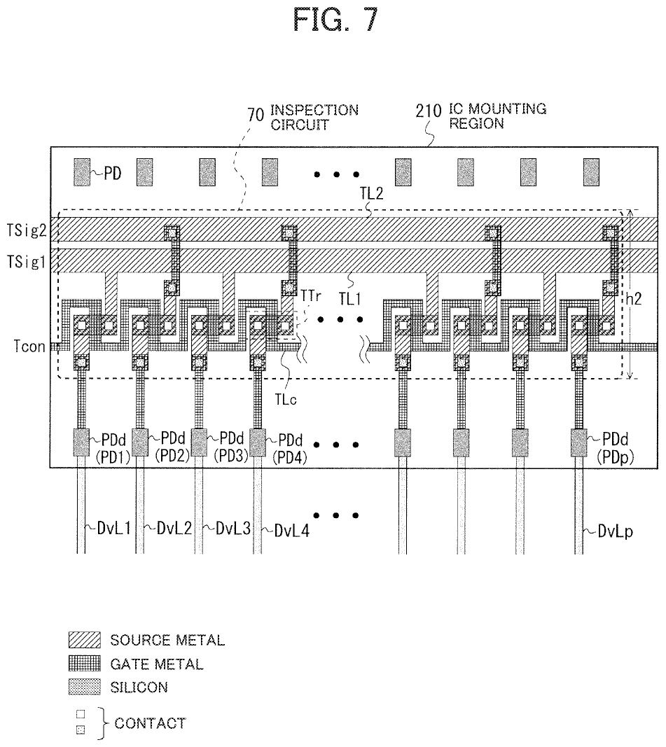

FIG. 7 is a diagram showing a layout pattern of an inspection circuit 70 formed in the IC mounting region 210 in the present embodiment. As shown in FIG. 7, as in the case of the inspection circuit 60 in the first embodiment, in the IC mounting region 210, pads PD are formed in positions corresponding separately to each of terminals of the driver IC 200 when the driver IC 200 is mounted in the active matrix substrate 100. To the driving-side pads PD1 to PDp, which are p pads of those pads PD situated beside the display unit 500, the video data lines DvL1 to DvLp are connected, respectively. The inspection circuit 70 includes p inspection transistors TTr (TTr1 to TTrp) serving as switching elements, arranged in a horizontal direction, that correspond to the video data lines DvL1 to DvLp, respectively, a first inspection signal line TL1 formed as a wire extending in the horizontal direction, a second inspection signal line TL2 formed as a wire extending in the horizontal direction, and an inspecting control line TLC formed as a wire repeatedly bent in a serpentine form.

As shown in FIG. 7, the source and the drain, which are formed by source metal, in each inspection transistor TTrk are arranged in the horizontal direction (in the drawing, a right-left direction). One of the source and the drain, namely the first conducting terminal, is connected to a corresponding video data line DvLk (k=1 to p) via a gate metal wire and a driving-side pad PDk, and the other of the source and drain, namely the second conducting terminal, is connected to the first inspection signal line TL1 or the second inspection signal line TL2. As shown in FIG. 7, the inspecting control line TLC is formed as a gate metal wire repeatedly bent in a serpentine form so as to pass above or below the channel regions of all inspection transistors TTr1 to TTrp and not to intersect the other wires.

In the layout pattern of the inspection circuit 70 in the present embodiment thus described, as in the layout pattern of the inspection circuit 60 in the first embodiment (FIG. 3), there are no wire intersections in a region between the inspection transistors TTr (TTr1 to TTrp) and the driving-side pads PD (PD1 to PDp). For this reason, as with the first embodiment, the present embodiment brings about further improvement than ever before in ESD resistance of the inspection circuit 70 formed in the IC mounting region 210 of the active matrix substrate 100.

Further, the present embodiment needs a smaller region for wiring of the inspecting control line TLC in the inspection circuit 70 than the first embodiment. For this reason, the vertical size, i.e. height h2, of the inspection circuit 70 in the present embodiment is smaller than the height h1 of the inspection circuit 60 in the first embodiment (see FIGS. 3 and 7). This makes it possible to increase the length of a gate metal wire that is formed between the first conducting terminal of each inspection transistor TTrk and a driving-side pad PDk to which a video data line DvLk is connected, which contributes to improvement in ESD resistance. Further, since the inspecting control line TLC does not intersect any of the wires, the total number of wire intersections in the inspection circuit is smaller than in the first embodiment, which too contributes to improvement in ESD resistance. Furthermore, since the height h2 of the inspection circuit 70 is small, a driver IC 200 in which the distance between upper and lower pads (i.e. the distance between pads in a vertical direction) is short can be mounted.

### 3. Third Embodiment

Next, a liquid crystal display device including an active matrix substrate according to a third embodiment (hereinafter referred to as “display device of the third embodiment”) is described. Since the display device of the third embodiment is the same in configuration as the display device of the first embodiment (see FIGS. 1 and 2) except for the layout pattern of an inspection circuit formed in an IC mounting region in the active matrix substrate, identical or corresponding components are given identical reference signs and not described in detail. The layout pattern of an inspection circuit 80 in the present embodiment is basically the same as the layout pattern of the inspection circuit 70 in the second embodiment (see FIG. 7). Components and actions of the present embodiment that are not newly described are the same as those of the second embodiment.

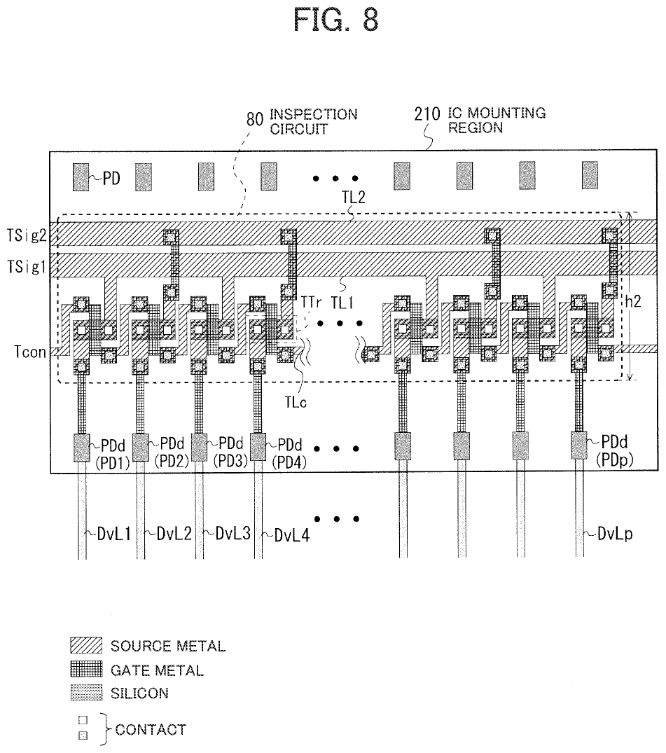

FIG. 8 is a diagram showing the layout pattern of the inspection circuit 80 in the present embodiment. As can be seen by comparing FIG. 8 with FIG. 7, the layout pattern of the inspection circuit 80 in the present embodiment is the same as the layout pattern of the inspection circuit 70 in the second embodiment except for the configuration of the inspecting control line TLC. The configuration of the inspecting control line TLC of the inspection circuit 80 in the present embodiment is the same as the configuration of the inspecting control line TLC of the inspection circuit 70 in the second embodiment in that the inspecting control line TLC is formed as a gate metal wire repeatedly bent in a serpentine form so as to pass above or below the channel regions of all inspection transistors TTr1 to TTrp and not to intersect the other wires. Further, the inspection circuit 70 in the present embodiment and the inspection circuit 80 in the second embodiment are equal in height (vertical size) of the inspection circuit. However, in the present embodiment, the inspecting control line TLC of the inspection circuit 80 is configured by a gate metal wire and a source metal wire being alternately connected as shown in FIG. 8. In this respect, the present embodiment differs from the inspection circuit 70 in the second embodiment, whose inspecting control line TLC is constituted by one gate metal wire alone as shown in FIG. 7.

In the present embodiment thus described, as in the first and second embodiments, there are no wire intersections in a region between the inspection transistors TTr (TTr1 to TTrp) and the driving-side pads PD (PD1 to PDp). This brings about further improvement than ever before in ESD resistance of the inspection circuit 80 formed in the IC mounting region 210 of the active matrix substrate 100. Further, since the inspecting control line TLC does not intersect any of the wires, the total number of wire intersections in the inspection circuit is smaller than in the first embodiment, which too contributes to improvement in ESD resistance. Furthermore, as in the second embodiment, the height h2 of the inspection circuit 80 is smaller than the height h1 of the inspection circuit 60 in the first embodiment. This makes it possible to further improve ESD resistance by increasing the length of a gate metal wire that is formed between the first conducting terminal of each inspection transistor TTrk and a driving-side pad PDk and mount a driver IC 200 in which the distance between upper and lower pads (i.e. the distance between pads in a vertical direction) is short.

In addition to these, in the present embodiment, in which the inspecting control line TLC of the inspection circuit 80 is constituted by a gate metal wire and a source metal wire being alternately connected, the area per wiring pattern is small, whereby the amount of electric charge due to electrostatic discharge or other reasons in the process of manufacturing a display panel including the active matrix substrate 100 is reduced. As a result, a breakdown of an interlayer insulating film or other components due to ESD occurring in the manufacturing process can be suppressed.

### 4. Fourth Embodiment

Next, a liquid crystal display device including an active matrix substrate according to a fourth embodiment (hereinafter referred to as “display device of the fourth embodiment”) is described. Since the display device of the fourth embodiment is the same in configuration as the display device of the first embodiment (see FIGS. 1 and 2) except for the layout pattern of an inspection circuit formed in an IC mounting region in the active matrix substrate, identical or corresponding components are given identical reference signs and not described in detail. Components and actions of the present embodiment that are not newly described are the same as those of the second embodiment.

In an active matrix substrate 100 such as that shown in FIG. 1, the inspection transistors TTr serving as switching elements included in the inspection circuit 60 need to be made lower in on-resistance; therefore, their channel widths are usually comparatively larger than the pitches between the video data lines DvL1 to DvLp. For example, whereas the pitches between the video data lines DvL1 to DvLp are 6 to 8μm, the channel widths of the inspection transistors TTr are greater than or equal to 15 μm. For this reason, as shown in FIGS. 3, 7, and 8, in the first to third embodiments, each inspection transistor TTr included in the inspection circuits 60, 70, and 80 is configured such that the source and the drain are arranged in a horizontal direction (in the drawing, a right-left direction) (the same applies to the inspection circuit 60a as the comparative example shown in FIG. 4). In FIGS. 3, 7, and 8, for illustrative purposes, the size ratios of the channel widths to the channel lengths of the inspection transistors TTr and the size ratios of these channel widths and channel lengths to the pitches between the video data lines DvL1 to DvLp are different from actual size ratios.

However, in a case where the pitches between the video data lines DvL1 to DvLp are comparatively larger than the channel widths of inspection transistors included in an inspection circuit, an inspection transistor in which the source and the drain are arranged in a vertical direction (in the drawing, an up-down direction) can be used. An inspection circuit 90 in the present embodiment is configured to use such an inspection transistor.

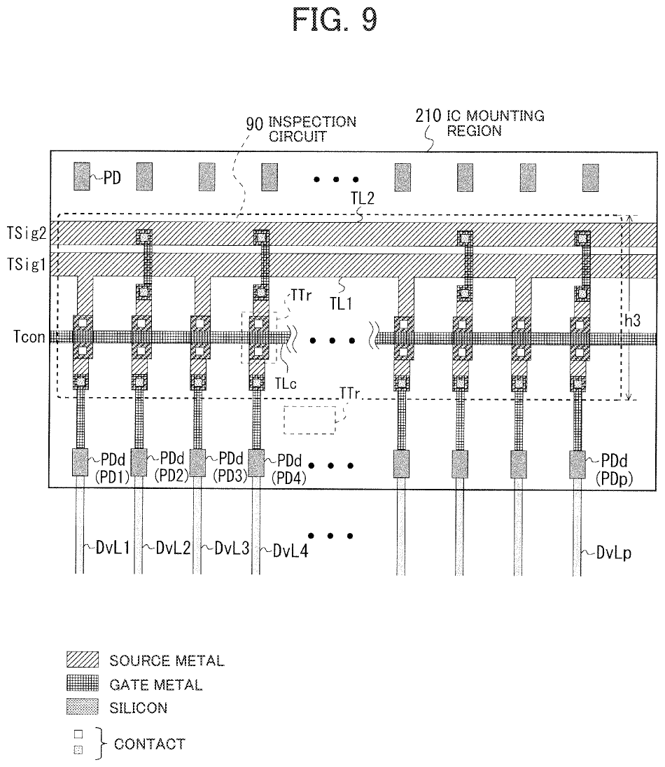

FIG. 9 is a diagram showing a layout pattern of an inspection circuit 90 in the present embodiment. As can be seen by comparing FIG. 9 with FIG. 7, the inspection circuit 90 in the present embodiment differs from the inspection circuit 70 in the second embodiment, in which the source and the drain of each inspection transistor TTr are arranged in a horizontal direction, in that the source and the drain of each inspection transistor TTr are arranged in a vertical direction. That is, the layout of each inspection transistor TTr included in the inspection circuit 90 in the present embodiment is the one obtained by rotating ninety degrees counterclockwise the layout of each inspection transistor TTr included in the inspection circuit 70 in the second embodiment. As such, the inspecting control line TLc is formed as one gate metal wire extending in a linear fashion so as to pass above or below the channel regions of all inspection transistors TTr1 to TTrp and not to intersect the other wires, and this constitutes a point of difference from the inspection circuit 70 in the second embodiment, whose inspecting control line TLC is formed as a gate metal wire repeatedly bent in a serpentine form. The other components in the layout pattern of the inspection circuit 90 in the present embodiment are not described, as they are the same as those in the layout pattern of the inspection circuit 70 in the second embodiment.

According to the present embodiment thus described, the layout pattern of the inspection circuit 90 (see FIG. 9), which is substantially the same as the layout pattern of the inspection circuit 70 (see FIG. 7) in the second embodiment, is achieved using an inspecting control line TLC formed by a linear gate metal wire. This makes it possible to, while achieving the inspection circuit 90 in a comparatively simple layout pattern, bring about effects that are similar to those of the second embodiment. Note, however, that the present embodiment is not applicable in a case where the pitches between the video data lines DvL1 to DvLp, which are connected to the driving-side pads PD1 to PDp, respectively, of the inspection circuit, are comparatively smaller than the channel widths of the inspection transistors.

Although, in the inspection circuit 90 in the present embodiment, the inspecting control line TLC is formed as one linear wire from gate metal, the inspecting control line TLC may alternatively be formed as a linear wire constituted by alternately connecting gate metal and source metal. This way reduces the area per wiring pattern of the inspecting control line TLC, thus reducing the amount of electric charge due to electrostatic discharge or other reasons in the process of manufacturing a display panel including the active matrix substrate 100, bringing about effects that are similar to those of the third embodiment.

### 5. Fifth Embodiment

Next, a liquid crystal display device including an active matrix substrate according to a fifth embodiment (hereinafter referred to as “display device of the fifth embodiment”) is described. This display device is configured such that as in the first embodiment, in the active matrix substrate 100, a plurality of pixel circuits of a display unit 500 are formed, and a source line driving circuit 300 and a gate line driving circuit 400 are formed integrally with the plurality of pixel circuits; furthermore, a driver IC 200 is mounted. Further, this display device is a liquid crystal display device including an in-cell touch panel, and FIG. 10 is a diagram for explaining an example configuration of the touch panel in the present embodiment.

In the active matrix substrate 100, which constitutes a liquid crystal panel serving as a display panel in the present embodiment, as in the first embodiment (see FIG. 1), the display unit 500 is provided with source lines SL1 to

SLM serving as a plurality of (M) driving data lines, gate lines GL1 to GLN serving as a plurality of (N) scanning lines intersecting the plurality of source lines SL1 to SLM, a plurality of (M×N) pixel circuits Ps(i,j) (i=1 to N, j=1 to M) arranged in a matrix along the plurality of source lines SL1 to SLM and the plurality of gate lines GL1 to GLN. In addition to these, as shown in FIG. 10, the display unit 500 of the active matrix substrate 100 includes a plurality of rectangular common electrode elements 501 arranged in a matrix. One common electrode element 501 is for example substantially in the shape of a square several millimeters on a side, and is larger than a pixel electrode. The common electrode elements 501 are not only used as electrodes for image display but also used as sensor electrodes for performing a function of the touch panel. The common electrode elements 501 are hereinafter called “sensor electrodes 501”.

In the present embodiment, in addition to including a circuit that drives pixel circuits Ps(1,1) to Ps(N,M) via video data lines or other lines for image display, the driver IC 200 includes a driving and readout circuit for performing the function of the touch panel. As shown in FIG. 10, the active matrix substrate 100 are also provided with a plurality of sensor signal lines 502 corresponding separately to each of the plurality of sensor electrodes 501 and extending parallel to the source lines SL1 to SLM (not illustrated in FIG. 10). Each of the sensor electrodes 501 is electrically connected to a corresponding one of the sensor signal lines 502 via several contact holes (not illustrated) and connected to the driver IC 200 via the corresponding sensor signal line 502. Each of the sensor electrodes 501 is used for applying a voltage for image display between the sensor electrode 501 and a pixel electrode and also used to form a capacitor for detecting a touch position.

FIG. 11 is a timing chart for schematically explaining the operation of the touch panel in the present embodiment. The display device according to the present embodiment is configured such that as shown in FIG. 11, an image writing period Tvideo during which to perform writing of data for image display on the liquid crystal panel and a scan pause period Tsens during which to detect a touch position on the display unit 500 of the liquid crystal panel alternately appear in one frame period (one vertical scanning period).

In an image writing period Tvideo, the driver IC 200 drives the source lines SL1 to SLM via the source line driving circuit 300 in tandem with the driving of the gate lines GL1 to GLN by the gate line driving circuit 400 with a DC voltage supplied as a common voltage Vcom to each sensor electrode 501 by a sensor signal line 502, whereby each piece of pixel data representing an image to be displayed is written as a data voltage to a corresponding pixel circuit Ps(i,j).

Meanwhile, in a pause period Tsens for touch position detection, the driver IC 200 supplies an AC signal of a certain amplitude as a sensor signal to each sensor electrode 501 via a sensor signal line 502 with the driving of the gate lines GL1 to GLN and the source lines SL1 to SLM under suspension. When a person's finger or other objects touch a position on the display unit 500 in the liquid crystal panel, a capacitor is formed between a sensor electrode 501 in the position touched and the person's finger or other objects. The driver IC 200 detects, in accordance with the AC signal, a change in capacitance at the sensor electrode 501 in the position touched (touch position). The function of the touch panel is performed by thus detecting the change in capacitance at the sensor electrode 501 in the touch position.

The following describes, with reference to FIG. 10, an inspection circuit 91 in the active matrix substrate 100 according to the present embodiment. In the present embodiment, the inspection circuit 91 is provided for outputting inspection signals to the sensor electrodes 501 provided in the active matrix substrate 100 in such a display device including an in-cell touch panel. The inspection circuit 91 is achieved by a layout pattern that is similar to that of any of the inspection circuits 60, 70, 80, and 90 in the first to fourth embodiments. Note, however, that the plurality of inspection transistors TTr included in the inspection circuit 91 correspond separately to each of the plurality of sensor signal lines 502, and to each of the plurality of driving-side pads PDd formed in the IC mounting region 210, the plurality of sensor signal lines 502 are connected separately instead of the video data lines DvL1 to DvLp. When a driver IC 200 is mounted, the plurality of driving-side pads PDd are used for the driver IC 200 to output a plurality of sensor signals.

The present embodiment thus described too brings about effects that are similar to those of any of the inspection circuits 60, 70, 80, and 90 in the already-described first to fourth embodiments.

### 6. Modifications

The present disclosure is not limited to the foregoing embodiments but may be variously modified without departing from the scope of the present disclosure.

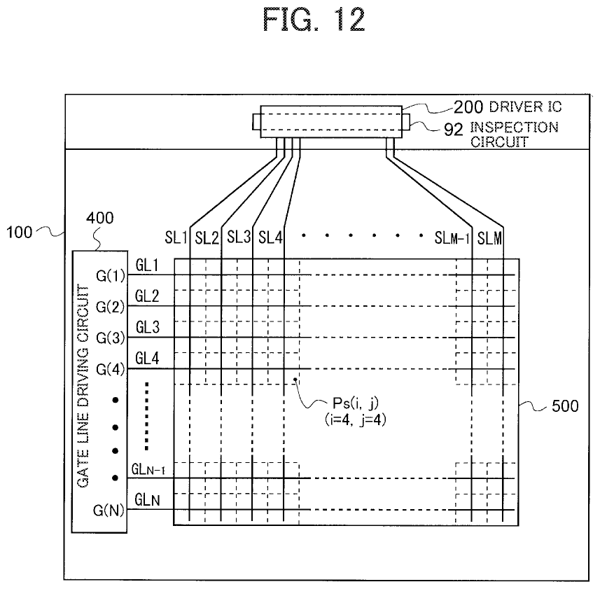

For example, the active matrix substrates 100 according to the first to fourth embodiments are each configured such that as shown in FIG. 1, a source line driving circuit 300 such as a demultiplexing circuit is provided between an inspection circuit 60, 70, 80, or 90 formed in an IC mounting region 210 and a display unit 500 and the source line driving circuit 300 generates driving data signals D(1) to D(M) in accordance with video data signals Dv1 to Dvp outputted from the driver IC 200 and applies the driving data signals D(1) to D(M) to source lines SL1 to SLM serving as driving data lines. However, alternatively, the active matrix substrate 100 may not be provided with the source line driving circuit 300, and M driving-side pads PDd provided in the IC mounting region 210 may be directly connected separately to each of the source lines SL1 to SLM in the display unit 500. FIG. 12 is a block diagram showing an overall configuration of a display device including an active matrix substrate 100 according to a modification of the first to fourth embodiments. In this modification, when a driver IC 200 is mounted in an IC mounting region, the M driving-side pads PDd are used for the driver IC 200 to output driving data signals D(1) to D(M). Moreover, in this modification, an inspection circuit 92 formed in the IC mounting region 210 is achieved by a layout pattern that is similar to any of the layout patterns of the inspection circuits 60, 70, 80, and 90 shown in FIGS. 3, 7, 8, and 9, respectively. Note, however, that the inspection circuit 92 includes M inspection transistors TTr1 to TTrM serving as switching elements (p=M), and the first conducting terminals (either the sources or drains) of the inspection transistors TTr1 to TTrM are connected to the source lines SL1 to SLM via the M driving-side pads PDd (PD1 to PDM), respectively. Further, once a driver IC 200 is mounted, the driver IC 200 directly drives the source lines SL1 to SLM by applying the M driving data signals D(1) to D(M) to the source lines SL1 to SLM. Such a modification too brings about effects that are similar to those of any of the first to fourth embodiments.

Further, the configurations of the inspection circuits 60, 70, 80, and 90 in the respective embodiments are not limited to the configurations shown in FIGS. 7 to 9, and for example, other transistors (TFTs) than the inspection transistors TTr may be included in the inspection circuits 60, 70, 80, and 90. Furthermore, although, in the inspection circuits 60, 70, 80, and 90 in the respective embodiments, two inspection signal lines consisting of first and second inspection signal lines TL1 and TL2 and one inspecting control line TLC are disposed, one or three or more inspection signal lines may be disposed, and two or more inspecting control lines may be disposed.

While the foregoing has described embodiments by

taking liquid crystal display devices as examples, the present disclosure is not limited to liquid crystal display devices but is also applicable to other types of display device such as organic EL (electroluminescence) display devices, provided such a display device includes an active matrix substrate having an inspection circuit formed in an IC mounting region 210. In a case where a display device according to the embodiments is an active matrix organic EL display device, the pixel circuit Ps(i,j) shown in FIG. 2 includes, instead of a TFT 10 serving as a pixel switching element, a liquid crystal capacitor Clc, or other components, an organic EL element (also called “organic light-emitting diode (OLED)”), a retaining capacitor, a TFT serving as a driving transistor, a TFT serving as a writing control switching element, or other components. In this case, the voltage of a source line SLj, i.e. the voltage of a driving data signal D(j), is written to the retaining capacitor via the writing control switching element, which is turned on/off by a gate line GLi, and the driving transistor supplies the organic EL element with a current corresponding to the voltage retained in the retaining capacitor. This causes the organic EL element to emit light with a luminance corresponding to the voltage written to the retaining capacitor.

It should be understood by those skilled in the art that various modifications, combinations, sub-combinations and alterations may occur depending on design requirements and other factors insofar as they are within the scope of the appended claims or the equivalents thereof.

What is claimed is:

1. An active matrix substrate having a display unit in which a plurality of pixel circuits are formed, the active matrix substrate comprising:
a plurality of driving data lines for transmitting, to the plurality of pixel circuits, a driving data signal representing an image to be displayed on the display unit; and
an inspection circuit formed in an IC mounting region in which an integrated circuit configured to generate a plurality of driving data signals for directly driving the plurality of driving data lines or a plurality of video data signals for indirectly driving the plurality of driving data lines via a predetermined driving circuit is to be mounted,
wherein
in the IC mounting region, a plurality of driving-side pads are formed for the integrated circuit to output the plurality of driving data signals or the plurality of video data signals,
the inspection circuit includes
a plurality of switching elements corresponding separately to each of the plurality of driving-side pads,
at least one inspection signal line for transmitting an inspection signal for inspecting the active matrix substrate, and
an inspecting control line for transmitting a control signal to be supplied to the plurality of switching elements,
each of the plurality of switching elements has a first conducting terminal connected to a corresponding one of the driving-side pads, a second conducting terminal connected to any of the at least one inspection signal line, and a control terminal connected to the inspecting control line, and
the at least one inspection signal line is formed opposite the plurality of driving-side pads across the plurality of switching elements.

2. The active matrix substrate according to claim 1, further comprising:
a data line driving circuit formed between the IC mounting region and the display unit and connected to the plurality of driving data lines; and
a plurality of video data lines formed to be connected separately to each of the plurality of driving-side pads for transmitting the plurality of video data signals from the integrated circuit to the data line driving circuit,
wherein
when mounted in the IC mounting region, the integrated circuit applies the video data signals to the plurality of video data lines via the plurality of driving-side pads, and
the data line driving circuit is configured to receive the plurality of video data signals via the plurality of video data lines, generate the plurality of driving data signals in accordance with the plurality of video data signals, and apply the plurality of driving data signals separately to each of the plurality of driving data lines.

3. The active matrix substrate according to claim 2, wherein
the integrated circuit generates, as the plurality of video data signals, a plurality of time-division multiplexed signals representing an image to be displayed on the display unit, and
the data line driving circuit is a demultiplexing circuit configured to generate the plurality of driving data signals by demultiplexing the plurality of video data signals.

4. The active matrix substrate according to claim 1, wherein
the plurality of driving-side pads are connected separately to each of the plurality of driving data lines, and
when mounted in the IC mounting region, the integrated circuit applies the plurality of driving data signals to the plurality of driving data lines via the plurality of driving-side pads.

5. An active matrix substrate having a display unit having formed therein a plurality of sensor electrodes arranged in a matrix for a touch panel function, the active matrix substrate comprising:
an inspection circuit formed in an IC mounting region in which an integrated circuit configured to generate a plurality of sensor signals to be supplied to the plurality of sensor electrodes is to be mounted; and
a plurality of sensor signal lines for transmitting the plurality of sensor signals to the plurality of sensor electrodes,
wherein
in the IC mounting region, a plurality of driving-side pads are formed for the integrated circuit to output the plurality of sensor signals,
the inspection circuit includes
a plurality of switching elements corresponding separately to each of the plurality of driving-side pads,
at least one inspection signal line for transmitting an inspection signal to be supplied to the plurality of sensor electrodes, and
an inspecting control line for transmitting a control signal to be supplied to the plurality of switching elements,
each of the plurality of switching elements has a first conducting terminal connected to a corresponding one of the driving-side pads, a second conducting terminal connected to any of the at least one inspection signal line, and a control terminal connected to the inspecting control line, and
the at least one inspection signal line is formed opposite the plurality of driving-side pads across the plurality of switching elements.

6. The active matrix substrate according to claim 1, wherein the inspecting control line is formed opposite the plurality of driving-side pads across the plurality of switching elements.

7. The active matrix substrate according to claim 1, wherein the inspecting control line is formed so as to pass above or below the plurality of switching elements and not to intersect any of wires connected to the first and second conducting terminals of the plurality of switching elements.

8. The active matrix substrate according to claim 7, wherein
the plurality of switching elements are thin-film transistors arranged in a first direction perpendicular to the plurality of driving data lines,
in each of the plurality of switching elements, the first conducting terminal and the second conducting terminal are formed to be arranged in the first direction, and
the inspecting control line is formed as a wire repeatedly bent in a serpentine form so as to pass above or below channel regions of the plurality of switching elements and not to intersect any of wires connected to the first and second conducting terminals of the plurality of switching elements.

9. The active matrix substrate according to claim 8, wherein the inspecting control line is formed by alternately joining wiring parts at two wiring layers differing from each other.

10. The active matrix substrate according to claim 7, wherein
the plurality of switching elements are thin-film transistors arranged in a first direction perpendicular to the plurality of driving data lines,
in each of the plurality of switching elements, the first conducting terminal and the second conducting terminal are formed to be arranged in a second direction in which the plurality of driving data lines extend, and
the inspecting control line is formed as a wire extending in a linear fashion so as to pass above or below channel regions of the plurality of switching elements and not to intersect any of wires connected to the first and second conducting terminals of the plurality of switching elements.

11. A display device comprising the active matrix substrate according to claim 1.
